(19) United States
(12) Patent Application Publication
(10) Pub. No.: US 2022/0372226 A1
(43) Pub. Date: Nov. 24, 2022

(54) POLYIMIDE FILM, POLYAMIDE ACID AND VARNISH CONTAINING SAME, AND POLYIMIDE MULTILAYER BODY AND METHOD FOR PRODUCING SAME

(71) Applicant: MITSUI CHEMICALS, INC., Minato-ku, Tokyo (JP)

(72) Inventors: Kenichi FUKUKAWA, Shinagawa-ku, Tokyo (JP); Masaki OKAZAKI, Chiba-shi, Chiba (JP); Tatsuhiro URAKAMI, Ichihara-shi, Chiba (JP); Yutaka HISAMUNE, Chiba-shi, Chiba (JP)

(73) Assignee: MITSUI CHEMICALS, INC., Minato-ku, Tokyo (JP)

(21) Appl. No.: 17/765,726

(22) PCT Filed: Apr. 6, 2020
(86) PCT No.: PCT/JP2020/015463

§ 371 Date: Mar. 31, 2022

(30) Foreign Application Priority Data
Oct. 3, 2019 (JP) 2019-182840

(51) Int. Cl. C08G 73/10; C08J 5/18; B32B 27/34; B32B 37/06

(52) U.S. Cl. CPC C08G 73/1042; C08G 73/1082; C08J 5/18; B32B 27/34; B32B 37/06; C08J 2479/08

(57) ABSTRACT

The purpose of the present invention is to provide: a polyimide film which is able to be formed at relatively low temperatures, while being less susceptible to coloring and having high transparency; and a polyamide acid or varnish for achieving this polyimide film. This polyimide film contains a polyimide which is a polymerization product of a tetracarboxylic acid dianhydride component and a diamine component. The tetracarboxylic acid dianhydride component contains from 60% by mole to 100% by mole of a tetracarboxylic acid dianhydride of a specific structure relative to the total amount of the tetracarboxylic acid dianhydride; and the diamine component contains from 30% by mole to 70% by mole of an alicyclic diamine and from 30% by mole to 70% by mole of an alkylene diamine relative to the total amount of the diamine component.

### TECHNICAL FIELD

The present invention relates to a polyimide film, a polyamide acid and a varnish containing the same, and a polyimide laminate and a method for producing the same.

### BACKGROUND ART

Heretofore, epoxy resins and acrylic resins have been well known as colorless and transparent coating resins and binder resins. However, these resins have problems in terms of heat resistance and chemical resistance. In contrast, polyimides are excellent in heat resistance, chemical resistance, mechanical properties, electrical properties and the like. However, the conventional polyimides have a film forming temperature of approximately 300° C., and therefore a problem is that when such a polyimide is applied to form a film, the object to be coated (such as a substrate) cannot withstand the film forming temperature.

In recent years, it has been studied to apply polyimides, which are capable of forming a film at a relatively low temperature, as a coating film for a magnetic material and a binder for an inorganic substance and a metal particle. Among them, colorless and transparent polyimides have been expected to be applied in various fields because of their designability and easy coloring with pigments.

Various polyimides have heretofore been proposed. For example, a thermoplastic polyimide derived from a specific alicyclic diamine and a specific aromatic tetracarboxylic dianhydride has been proposed (see, Patent Literature (hereinafter, abbreviated as PTL) 1). In addition, a varnish of a polyimide derived from a specific alicyclic acid dianhydride and a specific aromatic diamine has been proposed (see, PTL 2).

### CITATION LIST

### Patent Literature

### PTL 1

### Japanese Patent No. 5365762

### PTL 2

### WO 2008/004615

### SUMMARY OF INVENTION

### Technical Problem

As described above, general polyimides have a high glass transition temperature. Thus, a problem of such polyimides is that, when they are applied to form a film, they must be heated to a high temperature and the object to be coated (such as a substrate) is easily affected. Accordingly, it has been studied to lower the glass transition temperature of the polyimide and thereby lower the film formation temperature.

However, lowering the glass transition temperature of the polyimide has been likely to lower the starting temperature of decomposition and lower the transparency of the formed film. In addition, for a conventional polyimide, it has been difficult to form it into a film and also to obtain a uniform polyimide, due to low flowability of the precursor of the polyimide, that is, a polyamide acid and a varnish of the polyamide acid. It has also been difficult to thermocompression bond it.

In contrast, the polyimide of PTL 2 described above can be dissolved in a solvent to form a varnish. However, a problem of such a polyimide is that the chemical resistance is low and the use of a film of the polyimide is likely to be limited.

From the above, there is a need for a polyimide film that can be easily formed, is low in coloring and is highly transparent and that can be bonded even at a relatively low temperature.

The present invention has been made in view of such circumstances. An object of the present invention is to provide a polyimide film that can be easily formed, is low in coloring and is highly transparent and that can be bonded even at a relatively low temperature, and a polyamide acid for obtaining the polyimide film and a varnish containing the polyamide acid. Another object of the present invention is to provide a method for producing the polyimide film.

### Solution to Problem

The present invention provides the following polyimide film.

[1] A polyimide film comprising a polyimide that is a polymerization product of a tetracarboxylic dianhydride component and a diamine component, wherein:

the tetracarboxylic dianhydride component contains 60 to 100 mol % of any compound selected from the group consisting of the following compounds A to C based on the total amount of the tetracarboxylic dianhydride component; and

the diamine component contains 30 to 70 mol % of an alicyclic diamine and 30 to 70 mol % of an alkylenediamine based on the total amount of the diamine component:

compound A: a biphenyltetracarboxylic dianhydride optionally having 3 or less substituents consisting of alkyl groups having 1 to 4 carbon atoms;

compound B: a naphthalenetetracarboxylic dianhydride optionally having 3 or less substituents consisting of alkyl groups having 1 to 4 carbon atoms; and

compound C: a bisphenyl-based tetracarboxylic dianhydride optionally having 3 or less substituents consisting of alkyl groups having 1 to 4 carbon atoms, the bisphenyl-based tetracarboxylic dianhydride having any of the following structures:

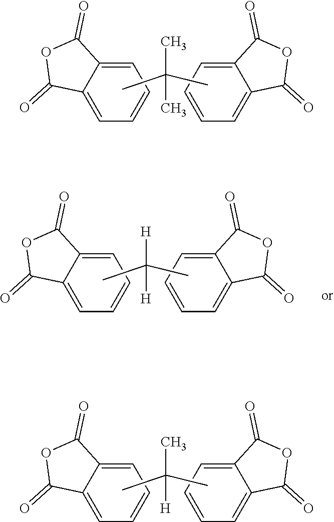

[2] A polyimide film comprising a polyimide that is a polymerization product of a tetracarboxylic dianhydride component and a diamine component, wherein:

the tetracarboxylic dianhydride component contains 60 to 100 mol % of a biphenyltetracarboxylic dianhydride optionally having 3 or less substituents consisting of alkyl groups having 1 to 4 carbon atoms based on the total amount of the tetracarboxylic dianhydride component; and

the diamine component contains 30 to 70 mol % of an alicyclic diamine and 30 to 70 mol % of an alkylenediamine based on the total amount of the diamine component.

[3] The polyimide film according to [1] or [2], wherein:

the alkylene group of the alkylenediamine has 2 to 12 carbon atoms.

[4] The polyimide film according to any one of [1] to [3], wherein:

the alicyclic diamine is at least one compound selected from the group consisting of 1,4-diaminomethylcyclohexane, 1,3-diaminomethylcyclohexane, norbornanediamine, cyclohexanediamine, isophoronediamine and 4,4′-methylenebis(cyclohexylamine).

[5] The polyimide film according to any one of [1] to [4], wherein:

the alicyclic diamine comprises 1,4-diaminomethylcyclohexane; and the alkylenediamine comprises 1,6-hexamethylenediamine.

[6] The polyimide film according to any one of [1] to [5], wherein:

the tetracarboxylic dianhydride component contains 40 mol % or less of 4,4′-oxydiphthalic anhydride.

The present invention provides the following polyamide acid and polyamide acid varnish comprising the polyamide acid.

[7] A polyamide acid that is a polymerization product of a tetracarboxylic dianhydride component and a diamine component, wherein:

the tetracarboxylic dianhydride component contains 60 to 100 mol % of any compound selected from the group consisting of the following compounds A to C based on the total amount of the tetracarboxylic dianhydride component; and

the diamine component contains 30 to 70 mol % of an alicyclic diamine and 30 to 70 mol % of an alkylenediamine based on the total amount of the diamine component:

compound A: a biphenyltetracarboxylic dianhydride optionally having 3 or less substituents consisting of alkyl groups having 1 to 4 carbon atoms;

compound B: a naphthalenetetracarboxylic dianhydride optionally having 3 or less substituents consisting of alkyl groups having 1 to 4 carbon atoms; and

compound C: a bisphenyl-based tetracarboxylic dianhydride optionally having 3 or less substituents consisting of alkyl groups having 1 to 4 carbon atoms, the bisphenyl-based tetracarboxylic dianhydride having any of the following structures:

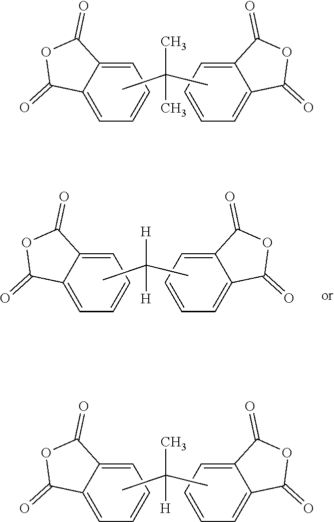

[8] A polyamide acid that is a polymerization product of a tetracarboxylic dianhydride component and a diamine component, wherein:

the tetracarboxylic dianhydride component contains 60 to 100 mol % of a biphenyltetracarboxylic dianhydride optionally having 3 or less substituents consisting of alkyl groups having 1 to 4 carbon atoms based on the total amount of the tetracarboxylic dianhydride component; and

the diamine component contains 30 to 70 mol % of an alicyclic diamine and 30 to 70 mol % of an alkylenediamine based on the total amount of the diamine component.

[9] The polyamide acid according to [7] or [8], wherein:

the alkylene group of the alkylenediamine has 2 to 12 carbon atoms.

[10] The polyamide acid according to any one of [7] to [9], wherein:

the alicyclic diamine is at least one compound selected from the group consisting of 1,4-diaminomethylcyclohexane, 1,3-diaminomethylcyclohexane, norbornanediamine, cyclohexanediamine, isophoronediamine and 4,4′-methylenebis(cyclohexylamine).

[11] The polyamide acid according to any one of [7] to [10], having an intrinsic viscosity of 0.62 dL/g or more.
[12] The polyamide acid according to any one of [7] to [11], wherein:

the alicyclic diamine comprises 1,4-diaminomethylcyclohexane; and

the alkylenediamine comprises 1,6-hexamethylenediamine.

[13] The polyamide acid according to any one of [7] to [12], wherein:

the tetracarboxylic dianhydride component contains 40 mol % or less of 4,4′-oxydiphthalic anhydride.

[14] A polyamide acid varnish, comprising the polyamide acid according to any one of [7] to [13] and a solvent.

The present invention provides the following polyimide laminate and method for producing the polyimide laminate.

[15] A method for producing a polyimide laminate having a substrate and a polyimide layer laminated, comprising:

applying the polyamide acid varnish according to [14] onto the substrate; and

heating the coating film of the polyamide acid varnish under an inert gas atmosphere.

[16] A method for producing a polyimide laminate having a substrate and a polyimide layer laminated, comprising:

applying the polyamide acid varnish according to [14] onto the substrate; and

heating the coating film of the polyamide acid varnish under an air atmosphere.

[17] A polyimide laminate comprising:

a substrate; and

the polyimide film according to any one of [1] to [6] disposed on or above the substrate.

### Advantageous Effects of Invention

The polyimide film of the present invention can be formed on various members at a relatively low temperature (such as a temperature of approximately 250° C.) and the polyimide film can be thermocompression bonded to other members at a relatively low temperature. In addition, the polyimide film is low in coloring and highly transparent. Therefore, the polyimide film can be applied as a coating material for various members and a binder for inorganic substances and metal particles.

### DESCRIPTION OF EMBODIMENTS

1. Polyimide Film

The polyimide film of the present invention comprises a specific polyimide that is a polymerization product of a specific tetracarboxylic dianhydride component and a specific diamine component. More particularly, the polyimide film of the present invention comprises a specific polyimide obtained by polymerizing: a tetracarboxylic dianhydride component containing 60 to 100 mol % of any tetracarboxylic dianhydride component selected from the group consisting of the following compounds A to C based on the total amount of the tetracarboxylic dianhydride component; and a diamine component containing 30 to 70 mol % of an alicyclic diamine and 30 to 70 mol % of an alkylenediamine based on the total amount of the diamine component:

compound A: a biphenyltetracarboxylic dianhydride optionally having 3 or less substituents consisting of alkyl groups having 1 to 4 carbon atoms;

compound B: a naphthalenetetracarboxylic dianhydride optionally having 3 or less substituents consisting of alkyl groups having 1 to 4 carbon atoms; and

compound C: a bisphenyl-based tetracarboxylic dianhydride optionally having 3 or less substituents consisting of alkyl groups having 1 to 4 carbon atoms, the bisphenyl-based tetracarboxylic dianhydride having any of the following structures:

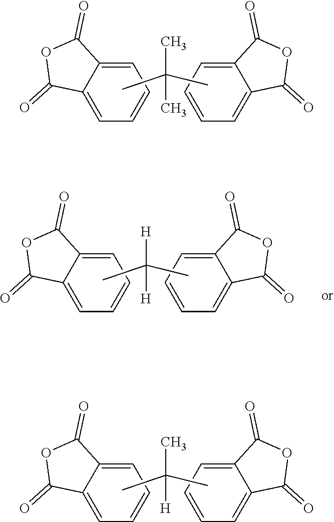

The polyimide film may contain a component other than the specific polyimide as long as the object and effect of the present invention are not impaired. However, the amount of the specific polyimide is preferably 80 mass % or more and more preferably 90 mass % or more based on the total mass of the polyimide film, and even more preferably, substantially all of the polyamide film is comprised of the specific polyimide.

Hereinafter, the specific polyimide will be described in detail.

(Tetracarboxylic Dianhydride Component)

The tetracarboxylic dianhydride component for preparing the specific polyimide contains 60 to 100 mol % of any compound selected from the group consisting of the above-described compounds A to C based on the total amount of the tetracarboxylic dianhydride component. The tetracarboxylic dianhydride component may contain only one of compounds A to C or may be contain two or more of them. However, the content of any one compound of compounds A to C is 60 to 100 mol % based on the total amount of the tetracarboxylic dianhydride component.

The tetracarboxylic dianhydride component preferably contains, among them, compound A (a biphenyltetracarboxylic dianhydride optionally having 3 or less substituents consisting of alkyl groups having 1 to 4 carbon atoms (BPDA; hereinafter, also referred to simply as “biphenyltetracarboxylic dianhydride”)) in an amount of 60 to 100 mol %. When the tetracarboxylic dianhydride component contains such a biphenyltetracarboxylic dianhydride, by-products (salts) are not easily produced during polymerization of a polyamide acid, and the diamine component and the tetracarboxylic dianhydride component is easily polymerized. In addition, when the amount of the biphenyltetracarboxylic dianhydride is within the above-described range, the transparency and thermocompression bonding properties of the polyimide film are good. Further, the biphenyltetracarboxylic dianhydride is relatively inexpensive, and the cost of the polyimide film can be thereby reduced. The amount of the biphenyltetracarboxylic dianhydride is preferably 80 mol % or more and more preferably 85 mol % or more based on the total amount of the tetracarboxylic dianhydride component.

Examples of the above-described compound A (biphenyltetracarboxylic dianhydride) include 3,3′,4,4′-biphenyltetracarboxylic dianhydride optionally having 3 or less substituents consisting of alkyl groups having 1 to 4 carbon atoms; and 2,2′,3,3′-biphenyltetracarboxylic dianhydride optionally having 3 or less substituents consisting of alkyl groups having 1 to 4 carbon atoms. The alkyl group as the substituent preferably has 1 or 2 carbon atoms. The total number of substituents may be 3 or less, and the substituents may be bonded at any position (ring) to the biphenyltetracarboxylic dianhydride. When the biphenyltetracarboxylic dianhydride has two or more substituents, they may be the same group or different groups.

Among the biphenyltetracarboxylic dianhydrides, 3,3′,4,4′-biphenyltetracarboxylic dianhydride is particularly preferable in terms of availability and the like.

Also when the tetracarboxylic dianhydride component contains compound B (a naphthalenetetracarboxylic dianhydride optionally having 3 or less substituents consisting of alkyl groups having 1 to 4 carbon atoms (hereinafter, also referred to simply as “naphthalenetetracarboxylic dianhydride”)) in an amount of 60 to 100 mol %, by-products (salts) are not easily produced during polymerization of a polyamide acid, and the diamine component and the tetracarboxylic dianhydride component is easily polymerized. In addition, when the amount of the naphthalenetetracarboxylic dianhydride in the tetracarboxylic dianhydride component is within the above-described range, the transparency and thermocompression bonding properties of the polyimide film are good. Further, the naphthalenetetracarboxylic dianhydride is relatively inexpensive, and the cost of the polyimide film can be thereby reduced. The amount of the naphthalenetetracarboxylic dianhydride is preferably 80 mol % or more and more preferably 85 mol % or more based on the total amount of the tetracarboxylic dianhydride component.

Examples of the above-described compound B (naphthalenetetracarboxylic dianhydride) include 2,3,6,7-naphthalenetetracarboxylic dianhydride optionally having 3 or less substituents consisting of alkyl groups having 1 to 4 carbon atoms; and 1,2,5,6-naphthalenetetracarboxylic dianhydride optionally having 3 or less substituents consisting of alkyl groups having 1 to 4 carbon atoms. The alkyl group as the substituent preferably has 1 or 2 carbon atoms. The total number of substituents may be 3 or less, and the substituents may be bonded at any position (ring) to the naphthalenetetracarboxylic dianhydride. When the naphthalenetetracarboxylic dianhydride has two or more substituents, they may be the same group or different groups.

Also when the tetracarboxylic dianhydride component contains compound C (a bisphenyl-based tetracarboxylic dianhydride having any of the above-described structures (hereinafter, also referred to simply as “bisphenyl-based tetracarboxylic dianhydride”)) in an amount of 60 to 100 mol %, by-products (salts) are not easily produced during polymerization of a polyamide acid, and the diamine component and the tetracarboxylic dianhydride component is easily polymerized. In addition, when the amount of the bisphenyl-based carboxylic dianhydride in the tetracarboxylic dianhydride component is within the above-described range, the transparency and thermocompression bonding properties of the polyimide film are good. Further, the bisphenyl-based tetracarboxylic dianhydride is relatively inexpensive, and the cost of the polyimide film can be thereby reduced. The amount of the bisphenyl-based tetracarboxylic dianhydride component is preferably 80 mol % or more and more preferably 85 mol % or more based on the total amount of the tetracarboxylic dianhydride.

Examples of the above-described compound C (bisphenyl-based tetracarboxylic dianhydride) include a bisphenyl-based tetracarboxylic dianhydride represented, for example, by any of the following structural formulae:

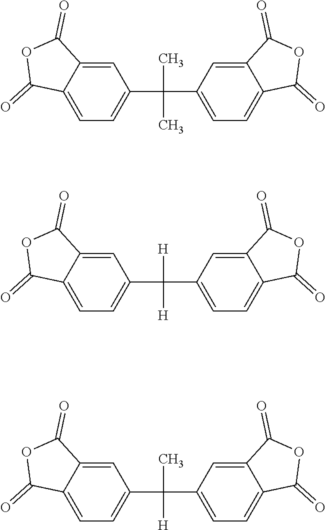 [SMILES: CC(C)(c1ccc2c(c1)C(=O)OC2=O)c1ccc2c(c1)C(=O)OC2=O ; O=C1OC(=O)c2cc(Cc3ccc4c(c3)C(=O)OC4=O)ccc21 ; CC(c1ccc2c(c1)C(=O)OC2=O)c1ccc2c(c1)C(=O)OC2=O]

The above-described compound may have 3 or less substituents consisting of alkyl groups having 1 to 4 carbon atoms. Each substituent (alkyl group) bonded to the bisphenyl-based tetracarboxylic dianhydride preferably has 1 or 2 carbon atoms. The total number of substituents may be 3 or less, and the substituents may be bonded at any position (ring) to the bisphenyl-based tetracarboxylic dianhydride. When the bisphenyl-based tetracarboxylic dianhydride has two or more substituents, they may be the same group or different groups.

The tetracarboxylic dianhydride component may further contain 4,4′-oxydiphthalic anhydride (ODPA). When the tetracarboxylic acid dianhydride component contains 4,4′-oxydiphthalic anhydride, the glass transition temperature of the polyimide film tends to be low and the starting temperature of decomposition tends to be high. The amount of the 4,4′-oxydiphthalic anhydride is preferably 0 to 40 mol % and more preferably 5 to 15 mol % based on the total amount of the tetracarboxylic dianhydride component. The 4,4′-oxydiphthalic anhydride (ODPA) may have 3 or less substituents consisting of alkyl groups having 1 to 4 carbon atoms, too.

The tetracarboxylic dianhydride component may contain a tetracarboxylic dianhydride other than the above-described compounds A to C and 4,4′-oxydiphthalic anhydride as long as the object and effect of the present invention are not impaired.

Examples of the other tetracarboxylic dianhydride include a known tetracarboxylic dianhydride, specifically, an optionally substituted aromatic tetracarboxylic dianhydride and alicyclic tetracarboxylic dianhydride.

The specific polyimide may partly contain, instead of the above-described tetracarboxylic dianhydride component, acid trianhydrides or acid tetraanhydrides. Examples of the acid trianhydrides include a hexacarboxylic trianhydride, and examples of the acid tetraanhydrides include an octacarboxylic tetraanhydride.

(Diamine Component)

The diamine component for preparing the specific polyimide contains 30 to 70 mol % of an acyclic diamine and 30 to 70% of an alkylenediamine based on the total amount of the diamine component. The combined amount of the alicyclic diamine and the alkylenediamine based on the total amount of the diamine component is preferably 80 mol % or more and more preferably 90 mol % or more, and all of the diamine component is preferably comprised of an alicyclic diamine and an alkylene diamine.

The amount of the alicyclic diamine is more preferably 35 to 65 mol % and even more preferably 45 to 55 mol % based on the total amount of the diamine component. The amount of the alkylenediamine is more preferably 35 to 65 mol % and even more preferably 45 to 55 mol % based on the total amount of the diamine component. The molar ratio of the alicyclic diamine to the alkylenediamine is 3/7 or more and 7/3 or less, more preferably 4/6 or more and 6/4 or less, and even more preferably 4.5/5.5 or more and 5.5/4.5 or less. When the molar ratio of the alicyclic diamine to the alkylenediamine is within the above-described range, the glass transition temperature and the light transmittance of the resulting polyimide film tend to fall within the desired range.

The alicyclic diamine may be any compound having an alicyclic structure and two amines, and the alicyclic structure may have a substituent or the like bonded thereto. Examples of the alicyclic diamine include 1,4-diaminomethylcyclohexane (1,4-BAC), 1,3-diaminomethylcyclohexane (1,3-BAC), norbornanediamine (NBDA), cyclohexanediamine (DACH), isophoronediamine and 4,4′-methylenebis(cyclohexylamine). The specific polyimide may contain only one alicyclic diamine or two or more of them.

Among them, the alicyclic diamine is preferably 1,4-diaminomethylcyclohexane. 1,4-Diaminomethylcyclohexane has geometric isomers comprised of cis and trans isomers, and any of these may be used. However, the content ratio of the trans isomer to the cis isomer (trans isomer+cis isomer=100%) is particularly preferably 60% or more and 100% or less of the trans isomer to 0% or more and 40% or less of the cis isomer. The content proportion of the cis isomer and the trans isomer can be identified by ¹H-NMR.

The alkylenediamine may be any compound having an alkylene group and two amines, and the alkylene group may have a substituent or the like bonded thereto. The alkylene group preferably have 2 to 12 carbon atoms. The alkylene group may be linear or branched, but it is preferably linear from the viewpoint that the glass transition temperature of the polyimide film tends to fall within the desired range. Specific examples of the alkylenediamine include 1,6-hexamethylenediamine (HMDA), 1,7-heptanediamine, 1,9-nonanediamine and 1,12-diaminododecane. The specific polyimide may contain only one alkylenediamine or two or more of them.

The diamine component may contain a diamine component other than the above-described alicyclic diamine and alkylenediamine as long as the object and effect of the present invention are not impaired. Examples of the other diamine include various known diamines, specifically, diamines having an aromatic ring, a diamine having a spirobiindane ring, siloxane diamines, ethylene glycol diamines, alkylenediamines and alicyclic diamines.

(2) Method for Producing Polyimide Film

The specific polyimide comprised in the polyimide film of the present invention can be obtained by polymerizing the above-described diamine component and tetracarboxylic dianhydride component by known method. The polyimide may be a random polymer or a block copolymer.

The polyimide film of the present invention can be obtained by: 1) polymerizing the above-described diamine component and tetracarboxylic dianhydride component to prepare a polyamide acid; 2) applying a polyamide acid varnish containing the polyamide acid onto a substrate to form a coating film; and 3) imidizing (cyclizing) the polyamide acid contained in the coating film.

When the polyimide to be prepared is a block copolymer, it can be obtained by: 1) reacting a polyamide acid oligomer and a polyimide oligomer to prepare a block polyamide acid imide; 2) applying a block polyamide acid imide varnish containing the block polyamide acid imide on a substrate to form a coating film; and 3) imidizing (cyclizing) the block polyamide acid imide contained in the coating film.

(Preparation of Polyamide Acid or Block Polyamide Acid Imide)

When the polyimide to be prepared is a random polymer, the above-described tetracarboxylic dianhydride component and diamine component are blended and polymerized to obtain a polyamide acid. The ratio (y/x) of the total molar amount of the tetracarboxylic acid dianhydride component (y) to the total molar amount of the diamine component (x) at the time of preparing the polyamide acid is preferably 0.970 to 1.100, more preferably 0.990 to 1.010, and even more preferably 0.995 to 1.005. By defining, the amount of the diamine component and the amount of the tetracarboxylic dianhydride component at the time of preparing the polyamide acid, to be in the above range, the intrinsic viscosity of the obtained polyamide acid can be easily in the desired range.

The method for polymerizing the diamine component and the tetracarboxylic dianhydride component is not particularly limited, and it may be any known method. For example, a vessel equipped with a stirrer and a nitrogen inlet tube is provided, and a solvent is charged into the vessel that has been subjected to nitrogen purging. A diamine component is then added thereto so that the final solid content concentration of the polyamide acid is 50 mass % or less, followed by temperature adjustment and stirring. A tetracarboxylic dianhydride is added in a predetermined amount to the resulting solution. It is thereafter stirred for approximately 1 to 50 hours while adjusting the temperature.

The solvent to be used at the time of preparing the polyamide acid is not particularly limited as long as the solvent can dissolve the above-described diamine component and tetracarboxylic dianhydride component. For example, the solvent may be an aprotic polar solvent and/or a water-soluble alcohol-based solvent, or the like.

Examples of the aprotic polar solvent include N-methyl-2-pyrrolidone, N,N-dimethylformamide, N,N-dimethylacetamide, dimethyl sulfoxide, hexamethylphosphoramide and 1,3-dimethyl-2-imidazolidinone; and an ether-based compound such as 2-methoxyethanol, 2-ethoxyethanol, 2-(methoxymethoxy)ethoxyethanol, 2-isopropoxyethanol, 2-butoxyethanol, tetrahydrofurfuryl alcohol, diethylene glycol, diethylene glycol monomethyl ether, diethylene glycol monoethyl ether, diethylene glycol monobutyl ether, triethylene glycol, triethylene glycol monoethyl ether, tetraethylene glycol, 1-methoxy-2-propanol, 1-ethoxy-2-propanol, dipropylene glycol, dipropylene glycol monomethyl ether, dipropylene glycol monoethyl ether, tripropylene glycol monomethyl ether, polyethylene glycol, polypropylene glycol, tetrahydrofuran, dioxane, 1,2-dimethoxyethane, diethylene glycol dimethyl ether and diethylene glycol diethyl ether.

Examples of the water-soluble alcohol-based solvent include methanol, ethanol, 1-propanol, 2-propanol, tert-butyl alcohol, ethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, 1,2,6-hexanetriol and diacetone alcohol.

The solvent to be used at the time of preparing the polyamide acid may contain only one of the above-described components or two or more of them. Among the above, the solvent is preferably N,N-dimethylacetamide, N-methyl-2-pyrrolidone or a mixture thereof.

On the other hand, when the polyimide to be prepared is a block copolymer, a specific diamine component and a specific tetracarboxylic dianhydride component are polymerized to previously prepare an amine-terminated polyamide acid oligomer and an acid anhydride-terminated polyimide oligomer. A solution of the acid anhydride-terminated polyimide oligomer is added to a solution of the amine-terminated polyamide acid oligomer and stirred, allowing them to be polymerized to obtain a block polyamide acid imide.

In order to obtain the specific polyimide, the intrinsic viscosity (η) of the polyamide acid or the block polyamide acid imide is preferably 0.62 dL/g or more. The intrinsic viscosity (η) is preferably 0.80 dL/g or more and more preferably 1.00 dL/g or more. The intrinsic viscosity (1) of the polyamide acid or the block polyamide acid imide can be adjusted by the type and amount of the diamine component and the tetracarboxylic dianhydride component at the time of preparing the polyamide acid or the block polyamide acid imide. As used herein, the intrinsic viscosity (η) is a value obtained by the measurement at a concentration of polyamide acid of 0.5 g/dL at 25° C. with an Ubbelohde viscometer tube. When the intrinsic viscosity (η) of the polyamide acid or the block polyamide acid imide is 0.62 dL/g or more, the thermocompression bonding properties of the resulting polyimide film tend to be good.

(Application of Varnish)

A polyamide acid varnish (or a block polyamide acid imide varnish; hereinafter, also collectively referred to simply as “varnish”) containing the above-described polyamide acid (or block polyamide acid imide) and a solvent is applied onto the surface of each of various substrates to form a coating film. The solvent contained in the varnish may be the same as or different from the solvent to be used for preparing the above-described polyamide acid. The varnish may contain only one solvent or two or more solvents.

The amount of the polyamide acid (or block polyamide acid imide) is preferably 1 to 50 mass % and more preferably 10 to 45 mass % based on the total amount of the varnish. When the amount of polyamide acid (or block polyamide acid imide) exceeds 50 mass %, the viscosity of the varnish is excessively high, and the varnish is sometimes difficult to apply onto the substrate. In contrast, when the concentration of polyamide acid (or block polyamide acid imide) is less than 1 mass %, the varnish is excessively low in viscosity and can sometimes not be applied in a desired thickness. In addition, it takes time to dry the solvent, and production efficiency of the polyimide film deteriorates.

The viscosity of the varnish is preferably 500 to 100,000 mPa-s, more preferably 3,000 to 60,000 mPa-s, and even more preferably 4,500 to 20,000 mPa-s. When the viscosity is within the above-described range, the varnish is easy to apply, and therefore a polyimide film having the desired thickness is easily obtained. The viscosity is measured at 25° C. with an E-type viscometer.

The substrate on which the varnish is applied is not particularly limited as long as it has solvent resistance and heat resistance. The substrate is preferably a substrate that has a good peelability from the resulting polyimide layer, and is preferably a flexible substrate made of glass, a metal, a heat-resistant polymer film or the like. Examples of the flexible substrate made of a metal include meal foils made of copper, aluminum, stainless steel, iron, silver, palladium, nickel, chromium, molybdenum, tungsten, zirconium, gold, cobalt, titanium, tantalum, zinc, lead, tin, silicon, bismuth, indium and an alloy of these metals. The surface of the metal foil may be coated with a mold release agent.

Examples of the flexible substrate made of a heat-resistant polymer film include a polyimide film, an aramid film, a polyether ether ketone film and a polyether ether sulfone film. The flexible substrate made of a heat-resistant polymer film may contain a mold release agent or an antistatic agent, or it may have the surface coated with a mold release agent or an antistatic agent. The substrate is preferably a polyimide film because the substrate has a good peelability from the resulting polyimide film and a high heat resistance and a high solvent resistance.

The form of the substrate is appropriately selected depending on the form of the polyimide film to be produced, and may be in the form of a single sheet or a continuous sheet. The thickness of the substrate is preferably 5 to 150 μm, and more preferably 10 to 70 μm. When the thickness of the substrate is less than 5 μm, the substrate may be wrinkled or torn during application of a varnish.

The method for applying the varnish onto the substrate is not particularly limited as long as the varnish can be applied in a constant thickness. Examples of the application apparatus include a die coater, a comma coater, a roll coater, a gravure coater, a curtain coater, a spray coater and a lip coater. The thickness of the coating film to be formed is appropriately selected depending on the desired thickness of the polyimide film.

(Imidization of Polyamide Acid (or Block Polyamide Acid Imide))

Subsequently, the coating film of the varnish containing the polyamide acid (or the block polyamide acid imide) is heated to imidize (cyclize) the polyamide acid (or the block polyamide acid imide). Specifically, the coating film of the varnish described above is heated while raising the temperature from 150° C. or less to more than 200° C. to imidize the polyamide acid (or block polyamide acid imide). At this time, the solvent in the coating film is removed. After raising the temperature to a predetermined temperature, the coating film is then heated at 220° C. or less for a certain period of time.

The temperature at which the polyamide acid is imidized is generally 150 to 220° C. Therefore, when the temperature of the coating film is rapidly raised to 220° C. or more, the polyamide acid on the surface of the coating film is imidized before the solvent volatilizes from the coating film. As a result, the solvent remaining in the coating film causes bubbles or causes asperities on the surface of the coating film. Therefore, in the temperature range of 150 to 220° C., it is preferable to gradually raise the temperature of the coating film. Specifically, the temperature rise rate in the temperature range of 150 to 220° C. is preferably 0.25 to 50° C./min, more preferably 1 to 40° C./Min, and even more preferably 2 to 30° C./min.

The temperature may be continuously or stepwisely (sequentially) raised, but when the temperature is continuously raised, the resulting polyimide film is less likely to exhibit a poor appearance. In the entire temperature range described above, the temperature rise rate may be constant or may be changed on the way.

Examples of the method for heating the coating film in the form of a single sheet while raising the temperature include a method for raising the temperature in an oven. In this case, the temperature rise rate is adjusted by setting the oven. When the coating film in the form of a continuous sheet is heated while raising the temperature, for example, a plurality of heating furnaces for heating the coating film are arranged along the conveying (moving) direction of the substrate; and the temperature of the heating furnaces is changed for each heating furnace. For example, the temperature of each heating furnace may be raised along the moving direction of the substrate. In this case, the temperature rise rate is adjusted by the conveying speed of the substrate.

As described above, it is preferable to heat the coating film at a temperature of 220° C. or less for a certain period of time after raising the temperature to reduce the amount of residual solvent in the polyimide film to 1 mass % or less. A conventional polyimide is required to be heated to 280° C. or more in order to reduce the amount of a residual solvent in a film. However, according to the above-described specific polyimide, the glass transition temperature can be 180 to 220° C. Therefore, the amount of residual solvent can be reduced to 1 mass % or less even by heating at 220° C. or less. The amount of solvent in the film is more preferably 0.5 mass % or less. The amount of residual solvent can be measured by a pyrolysis apparatus for a gas chromatography GC-1700 manufactured by Shimadzu Corporation. The heating time is usually approximately 0.5 to 2 hours.

The heating method for heating the above-described coating film at 220° C. or less is not particularly limited, and for example, the coating film may be heated in an oven or the like adjusted to a constant temperature. The coating film in the form of a continuous sheet may be heated in a heating furnace or the like kept at a constant temperature.

Even when a conventional polyimide is heated at 200° C., sufficient desolvation and imidization does not proceed. However, the polyimide of the present invention has Tg of approximately 200° C., and therefore, heating at 220° C. or less is sufficient and causes little coloring.

Meanwhile, when the heating atmosphere is an inert gas atmosphere, the coloring of the polyimide film is further reduced, and a polyimide film having a lower b* value can be obtained. The type of the inert gas used at this time is not particularly limited, and may be argon gas, nitrogen gas, or the like. Further, in the case, the oxygen concentration is preferably 5 vol % or less, more preferably 3 vol % or less and even preferably 1 vol % or less. The oxygen concentration in the atmosphere is measured by a commercially available oxygen densitometer (such as a zirconia oximeter).

After imidizing (cyclizing) the polyamide acid, the substrate can be peeled off to obtain a polyimide film. When the polyimide film is peeled off from the substrate, foreign matter may be adsorbed on the polyimide film due to charge at peeling. Therefore, it is preferable to: (i) coat the substrate with an antistatic agent, or (ii) provide, an apparatus for applying the polyamide acid and an apparatus for peeling off the polyimide film, with a member for eliminating static electricity (such as an antistatic bar, an antistatic thread or an ion blower-type static electricity eliminating apparatus).

(3) Physical Properties of Polyimide Film

The polyimide film containing the above-described specific polyimide can be thermocompression bonded to various members at a relatively low temperature, and is excellent in transparency. Therefore, it is very useful as a protective layer, a binder or the like for various members. Specifically, the polyimide film has the following physical properties.

(i) The glass transition temperature is 180° C. or more and 220° C. or less.

(ii) The starting temperature of decomposition is 355° C. or more.

(iii) The light transmittance at a wavelength of 400 nm is 77% or more.

(iv) The b* value in the L*a*b* color system is 5 or less.

Hereinafter, each requirement will be described in detail.

(i) Glass Transition Temperature

For the polyimide film containing the above-described specific polyimide, the glass transition temperature (Tg) can be 180° C. or more and 220° C. or less. The glass transition temperature (Tg) is more preferably 190 to 210° C. and even more preferably 194 to 205° C. When the glass transition temperature of the polyimide film is 180° C. or more, the heat resistance at the time of applying the polyimide film for various applications tends to be sufficient. On the other hand, when the glass transition temperature of the polyimide film is 220° C. or less, the polyimide film can be thermocompression bonded to various members, for example, at a temperature of 250° C. or less. In addition, when the glass transition temperature of the polyimide film is 220° C. or less, a solvent is sufficiently easily removed from the polyimide film even if the heating temperature at the time of producing the polyimide film is 220° C. or less. Therefore, not only the polyimide film can be produced at a low temperature, but also a solvent is less likely to remain in the polyimide film and the transmission of visible light tends to be good. The glass transition temperature is measured with a thermomechanical analysis apparatus (TMA).

The glass transition temperature of the polyimide film is adjusted by the structure or the like of the diamine component or the tetracarboxylic dianhydride component for preparing the polyimide. For example, when the diamine component contains a large amount of an alicyclic diamine, the glass transition temperature tends to be high, and when the diamine component contains a large amount of an alkylenediamine, the temperature tends to be low. Also when the above-described tetracarboxylic dianhydride component contains 4,4′-oxydiphthalic anhydride (ODPA), the glass transition temperature tends to be low.

(ii) Starting Temperature of Decomposition

For the polyimide film containing the above-mentioned specific polyimide, the starting temperature of decomposition of the polyimide film can be 355° C. or more. The starting temperature of decomposition is more preferably 360° C. or more and even more preferably 370° C. or more. When the starting temperature of decomposition of the polyimide film is 355° C. or more, the polyimide film can be attached to various elements or the like, and the heat at that time is less likely to decompose the polyimide film.

The starting temperature of decomposition of the polyimide film is measured with a thermomechanical analysis apparatus (TMA). In the present invention, the temperature at which 5 mg of the polyimide film decreases in mass by 1% when raising its temperature is taken as a starting temperature of decomposition. The starting temperature of decomposition of the polyimide film can be adjusted by the combination of the above-described tetracarboxylic dianhydride component and diamine component.

(iii) Light Transmittance at Wavelength of 400 nm

For the polyimide film containing the above-described specific polyimide, the light transmittance at a wavelength of 400 nm is 77% or more, preferably 80% or more and more preferably 84% or more. When the light transmittance at a wavelength of 400 nm of the polyimide film is 77% or more, the polyimide film has the yellowness suppressed, and it can be applied for the applications requiring transparency, such as an adhesive layer for a display element.

The light transmittance at a wavelength of 400 nm of the polyimide film is identified by measuring the UV-visible spectrum. The thickness of the polyimide film at the time of measuring the transmittance is not particularly limited, and the transmittance of the polyimide film actually produced (that is, the polyimide film having a thickness when used) is measured. The light transmittance at a wavelength of 400 nm of the polyimide film can be adjusted by the combination of the above-described tetracarboxylic dianhydride component and diamine component.

(iv) b* Value in L*a*b* Color System

For the polyimide film containing the above-described specific polyimide, the b* value in the L*a*b* color system is 5 or less. The b* value is preferably 3.0 or less and more preferably 1.0 or less. The b* value in L*a*b* color system represents the yellowness of the polyimide film, and the smaller value indicates the lower yellowness. When the b* value is 5 or less, at the time of using the polyimide film as the adhesive layer or the like for various displays, the adhesive layer becomes difficult to be visually recognized.

The b* value is a value measured for the polyimide film in the transmission mode using a colorimeter (such as a direct-reading tristimulus color meter (Color Cute i, CC-i type) manufactured by Suga Test Instruments Co., Ltd.). The thickness of the polyimide film at the time of measuring the b* value is not particularly limited, and the b* value of the polyimide film actually produced (that is, the polyimide film having a thickness when used) is measured.

The b* value is small, for example, when the intrinsic viscosity (η) of the polyamide acid from which a polyimide film is produced is 0.62 dL/g or more. In addition, by setting the atmosphere at the time of producing the polyimide film a nitrogen atmosphere, the polyimide is prevented from oxidation and the b* value tends to be low.

(v) Thickness

The thickness of the polyimide film containing the above-described specific polyimide is not particularly limited, and it is appropriately selected depending on the applications or the like of the polyimide film. For example, when the polyimide film is used as an adhesive sheet, the thickness can be approximately 5 to 10 μm. On the other hand, when the polyimide film is used as a protective layer for various members, it can be approximately 10 to 25 μm.

(vi) Coefficient of Thermal Expansion (CTE)

For the polyimide film containing the above-described specific polyimide, the coefficient of thermal expansion is preferably 40 to 70 ppm/K and more preferably 50 to 60 ppm/K. When the coefficient of thermal expansion is within the above-described range, the expansion and shrinkage due to a change in temperature can be reduced at the time of using the polyimide film for various applications.

For the coefficient of thermal expansion, a polyimide film is cut into a width of 4 mm and a length of 20 mm to prepare a sample. A temperature-specimen elongation curve is measured for the sample with a thermal analysis apparatus, and the slope in the range of 60° C. to 160° C. is taken as a coefficient of thermal expansion (CTE).

(vii) Haze

The haze of the polyimide film containing the above-described specific polyimide is preferably 1.5% or less and more preferably 1.0% or less. When the haze is within the above-described range, the polyimide film is easily applied even for the applications requiring a high transparency. The haze is measured with a hazemeter.

(viii) Total Light Transmittance

The total light transmittance of the polyimide film containing the above-described specific polyimide is preferably 80% or more and more preferably 85% or more. When the total light transmittance is within the above-described range, the polyimide film is easily applied for the applications requiring a high transparency. The total light transmittance is measured in accordance with JIS K7105.

(ix) Retardation in Thickness Direction (Rth)

The retardation in the thickness direction (Rth) per 10 μm in thickness of the polyimide film containing the above-described specific polyimide is preferably 60 or less and more preferably 50 or less. When the Rth is within the above-described range, the polyimide film can be used for an optical apparatus or the like.

(x) Mechanical Strength

The tensile strength of the polyimide film containing the above-described specific polyimide is preferably 100 MPa or more and more preferably 110 MPa or more. The tensile elongation of the polyimide film is preferably 5% or more and more preferably 20% or more. The tensile modulus is preferably 2.0 GPa or more and more preferably 2.5 GPa or more. When each of the tensile strength, tensile elongation and tensile modulus is within the above-described range, the strength of the polyimide film is enough high to be easily applied for various applications. The tensile modulus is calculated from a stress-strain curve obtained when a dumbbell-shaped punched specimen is prepared and is subjected to measurement with a tensile tester under the conditions of a gauge line width of 5 mm, a sample length of 30 mm and a tensile speed of 30 mm/min.

(4) Applications of Polyimide Film

As described above, the polyimide film of the present invention can be formed at a relatively low temperature, and it can be thermocompression bonded, for example, at approximately 250° C. In addition, it is low in coloring and is highly transparent. Therefore, it is suitable as a protective film, various binders, and the like.

2. Others

The above-described amide acid varnish or block polyamide acid imide varnish can be mixed with various material or the like to prepare a coating liquid for forming a coating film. For example, each of various coating films can be obtained by applying the coating liquid on a desired substrate and then imidizing the polyamide acid. At this time, the polyimide functions as a binder for binding various materials to the substrate.

As described above, the polyimide obtained by imidizing the above-described polyamide acid or block polyamide acid imide has a relatively low glass transition temperature. Therefore, it can be cured at approximately 220° C. and does not easily affect the substrate, when the coating film is produced. In addition, the above-described polyimide can be applied for various applications due to its high transparency, high heat resistance and the like.

Examples of various materials contained in the coating liquid include a magnetic substance, an inorganic particle, a metal particle, a pigment and a dye, but the various materials are not particularly limited thereto as long as they do not impair the object of the present invention.

The methods for applying the coating liquid and for heating it at the time of producing the coating film can be the same as the methods for applying the above-described varnish and for heating it.

### EXAMPLES

Hereinafter, the present invention will be described in more detail with reference to examples thereof. However, the scope of the present invention is not limited by them.

1. Tetracarboxylic dianhydride component and diamine component

The abbreviations of the tetracarboxylic dianhydride component and the diamine component used in Examples and Comparative Examples are as follows.

[Tetracarboxylic dianhydride component]

ODPA: 4,4′-oxydiphthalic anhydride

s-BPDA: 3,3′,4,4′-biphenyltetracarboxylic dianhydride

[Diamine Component]

1, 4-BAC: 1,4-bis(aminomethyl)cyclohexane

HMDA: 1,6-hexamethylenediamine

1. Preparation of polyamide acid varnish

### Synthesis Example 1

To a flask provided with a thermometer, a condenser, a nitrogen inlet tube and a stirring blade were added 1,4-BAC: 7.11 g (0.050 mol), HMDA: 5.81 g (0.050 mol) and N-methyl-2-pyrrolidone (NMP): 193.0 g, followed by stirring under a nitrogen atmosphere to obtain a uniform solution. Thereafter, it was cooled to 15° C. and s-BPDA: 26.3 g (0.090 mol) and ODPA: 3.10 g (0.010 mol) were charged thereinto in the form of powder followed by stirring as it was. After approximately 1 hour, heat was gradually generated, and an increase in viscosity was observed. It was allowed to increase in temperature and to react at an internal temperature of 60 to 70° C. for 1 hour to obtain a uniform solution. Thereafter, the solution was allowed to cool to room temperature and to age overnight at room temperature to obtain a viscous pale-yellow varnish. The obtained polyamide acid varnish had an intrinsic viscosity (η) (polymer concentration: 0.5 g/dL in NMP, measured at 25° C. with an Ubbelohde viscometer tube) of 1.18 dL/g and a viscosity of 12,200 mPa-s as measured at 25° C. with an E-type viscometer. Table 1 shows the composition and physical properties of the obtained polyamide acid.

### Synthesis Example 2

To the same reaction apparatus as in Synthesis Example 1 were added 1,4-BAC: 7.11 g (0.050 mol), HMDA: 5.81 g (0.050 mol) and N-methyl-2-pyrrolidone (NMP): 192.2 g, followed by stirring under a nitrogen atmosphere to obtain a uniform solution. Thereafter, it was cooled to 15° C. and s-BPDA: 29.28 g (0.10 mol) was charged thereinto in the form of powder followed by stirring as it was. After approximately 1 hour, heat was gradually generated, and an increase in viscosity was observed. It was allowed to increase in temperature and to react at an internal temperature of 60 to 70° C. for 1 hour to obtain a uniform solution. Thereafter, the solution was allowed to cool to room temperature and to age overnight at room temperature to obtain a viscous pale-yellow varnish. The obtained polyamide acid varnish had an intrinsic viscosity (η) (polymer concentration: 0.5 g/dL in NMP, measured at 25° C. with an Ubbelohde viscometer tube) of 1.00 dL/g and a viscosity of 28,400 mPa-s as measured at 25° C. with an E-type viscometer. Table 1 shows the composition and physical properties of the obtained polyamide acid.

### Synthesis Example 3

To the same reaction apparatus as in Synthesis Example 1 were added 1,4-BAC: 8.53 g (0.060 mol), HMDA: 4.65 g (0.040 mol) and N-methyl-2-pyrrolidone (NMP): 194.1 g, followed by stirring under a nitrogen atmosphere to obtain a uniform solution. Thereafter, it was cooled to 15° C. and s-BPDA: 26.33 g (0.090 mol) and ODPA: 3.10 g (0.010 mol) were charged thereinto in the form of powder followed by stirring as it was. After approximately 1 hour, heat was gradually generated, and an increase in viscosity was observed. It was allowed to increase in temperature and to react at an internal temperature of 60 to 70° C. for 1 hour to obtain a uniform solution. Thereafter, the solution was allowed to cool to room temperature and to age overnight at room temperature to obtain a viscous pale-yellow varnish. The obtained polyamide acid varnish had an intrinsic viscosity (η) (polymer concentration: 0.5 g/dL in NMP, measured at 25° C. with an Ubbelohde viscometer tube) of 0.77 dL/g and a viscosity of 6,300 mPa-s as measured at 25° C. with an E-type viscometer. Table 1 shows the composition and physical properties of the obtained polyamide acid.

### Synthesis Example 4

To the same reaction apparatus as in Synthesis Example 1 were added 1,4-BAC: 9.96 g (0.070 mol), HMDA: 3.49 g (0.030 mol) and N-methyl-2-pyrrolidone (NMP): 193.0 g, followed by stirring under a nitrogen atmosphere to obtain a uniform solution. Thereafter, it was cooled to 15° C. and s-BPDA: 26.33 g (0.090 mol) and ODPA: 3.10 g (0.010 mol) were charged thereinto in the form of powder followed by stirring as it was. After approximately 1 hour, heat was gradually generated, and an increase in viscosity was observed. It was allowed to increase in temperature and to react at an internal temperature of 60 to 70° C. for 1 hour to obtain a uniform solution. Thereafter, the solution was allowed to cool to room temperature and to age overnight at room temperature to obtain a viscous pale-yellow varnish. The obtained polyamide acid varnish had an intrinsic viscosity (T) (polymer concentration: 0.5 g/dL in NMP, measured at 25° C. with an Ubbelohde viscometer tube) of 1.14 dL/g and a viscosity of 53,800 mPa-s as measured at 25° C. with an E-type viscometer. Table 1 shows the composition and physical properties of the obtained polyamide acid.

### Synthesis Example 5

To the same reaction apparatus as in Synthesis Example 1 were added 1,4-BAC: 7.11 g (0.050 mol), HMDA: 5.81 g (0.050 mol) and N-methyl-2-pyrrolidone (NM P): 194.4 g, followed by stirring under a nitrogen atmosphere to obtain a uniform solution. Thereafter, it was cooled to 15° C. and s-BPDA: 20.45 g (0.070 mol) and ODPA: 9.31 g (0.030 mol) were charged thereinto in the form of powder followed by stirring as it was. After approximately 1 hour, heat was gradually generated, and an increase in viscosity was observed. It was allowed to increase in temperature and to react at an internal temperature of 60 to 70° C. for 1 hour to obtain a uniform solution. Thereafter, the solution was allowed to cool to room temperature and to age overnight at room temperature to obtain a viscous pale-yellow varnish. The obtained polyamide acid varnish had an intrinsic viscosity (η) (polymer concentration: 0.5 g/dL in NMP, measured at 25° C. with an Ubbelohde viscometer tube) of 1.15 dL/g and a viscosity of 53,800 mPa·s as measured at 25° C. with an E-type viscometer. Table 1 shows the composition and physical properties of the obtained polyamide acid.

### Comparative Synthesis Example 1

To the same reaction apparatus as in Synthesis Example 1 were added 1,4-BAC: 7.11 g (0.050 mol), HMDA: 5.81 g (0.050 mol) and N-methyl-2-pyrrolidone (NMP): 195.9 g, followed by stirring under a nitrogen atmosphere to obtain a uniform solution. Thereafter, it was cooled to 15° C. and s-BPDA: 14.56 g (0.050 mol) and ODPA: 15.51 g (0.050 mol) were charged thereinto in the form of powder followed by stirring as it was. After approximately 1 hour, heat was gradually generated, and an increase in viscosity was observed. It was allowed to increase in temperature and to react at an internal temperature of 60 to 70° C. for 1 hour to obtain a uniform solution. Thereafter, the solution was allowed to cool to room temperature and to age overnight at room temperature to obtain a viscous pale-yellow varnish. The obtained polyamide acid varnish had an intrinsic viscosity (η) (polymer concentration: 0.5 g/dL in NMP, measured at 25° C. with an Ubbelohde viscometer tube) of 0.73 dL/g and a viscosity of 5,700 mPa-s as measured at 25° C. with an E-type viscometer. Table 1 shows the composition and physical properties of the obtained polyamide acid.

TABLE 1

| | Tetracarboxylic | | | | Intrinsic | Viscosity |
|---|---|---|---|---|---|---|
| | dianhydride component | | Diamine component | | viscosity | with E-type |
| | (content molar ratio) | | (content molar ratio) | | (η) | viscometer |
| | ODPA | s-BPDA | 1,4-BAC | HMDA | [dL/g] | [mPa · s] |
| Synthesis | 10 | 90 | 50 | 50 | 1.18 | 12,200 |
| Example 1 | | | | | | |
| Synthesis | 0 | 100 | 50 | 50 | 1.00 | 28,400 |
| Example 2 | | | | | | |
| Synthesis | 10 | 90 | 60 | 40 | 0.77 | 6,300 |
| Example 3 | | | | | | |
| Synthesis | 10 | 90 | 70 | 30 | 1.14 | 53,800 |
| Example 4 | | | | | | |
| Synthesis | 30 | 70 | 50 | 50 | 1.15 | 53,800 |
| Example 5 | | | | | | |
| Comparative | 50 | 50 | 50 | 50 | 0.73 | 5,700 |
| Synthesis | | | | | | |
| Example 1 | | | | | | |

2. Production of Polyimide Film

### Example 1

The polyamide acid varnish prepared in Synthesis Example 1 was applied onto a glass substrate with a doctor blade to form a coating film of the polyamide acid varnish. A laminate consisting of the substrate and the coating film of the polyamide acid varnish was placed in an inert oven. Thereafter, the oxygen concentration in the inert oven was controlled to 0.1 vol % or less, and the temperature of the atmosphere in the oven was raised from 50° C. to 220° C. over 85 minutes (temperature rise rate: 2° C./min) and then kept at 220° C. for 2 hours. After the heating was completed, it was further allowed to cool naturally in the inert oven. Thereafter, a sample was immersed in distilled water to peel off a polyimide film from the substrate. Table 2 shows the thickness and various physical properties of the obtained polyimide film.

### Examples 2 to 5 and Comparative Example 1

Each of polyimide films was produced in the same manner as in Example 1 except that the polyamide acid varnish was changed to each of the polyamide acid varnish shown in Table 2. Table 2 shows the thickness and various physical properties of the obtained polyimide film.

### Example 6

The polyamide acid varnish prepared in Synthesis Example 1 was applied onto a glass substrate with a doctor blade to form a coating film of the polyamide acid varnish. A laminate consisting of the substrate and the coating film of the polyamide acid varnish was placed under an air atmosphere in an inert oven. Thereafter, the temperature of the atmosphere in the oven was raised from 50° C. to 220° C. over 85 minutes (temperature rise rate: 2° C./min) and then kept at 220° C. for 2 hours. After the heating was completed, it was further allowed to cool naturally in the inert oven. Thereafter, a sample was immersed in distilled water to peel off a polyimide film from the substrate. Table 2 shows the thickness and various physical properties of the obtained polyimide film.

### Examples 7 to 10

Each of polyimide films was produced in the same manner as in Example 6 except that the polyamide acid varnish was changed to each of the polyamide acid varnish shown in Table 2. Table 2 shows the thickness and various physical properties of the obtained polyimide film.

3. Evaluation Each of the polyimide films produced in Examples and Comparative Example was evaluated by the following methods.

1) Measurement of Glass Transition Temperature (Tg)

Each of the polyimide films produced in Examples and Comparative Example was cut into a width of 4 mm and a length of 20 mm to prepare a sample. The resulting sample was subjected to measurement of the glass transition temperature (Tg) with a thermal analysis apparatus (TMA-50) manufactured by Shimadzu Corporation.

2) Measurement of Starting Temperature of Decomposition (Tdl)

Five milligrams of each of the polyimide films produced in Examples and Comparative Example was weighed out to prepare a sample, and the resulting sample was subjected to measurement to the starting temperature of decomposition by raising the temperature at a rate 10° C./min with a thermal analysis apparatus (TMA-60) manufactured by Shimadzu Corporation. The temperature at which the sample decreased in mass by 1% was taken as a starting temperature of decomposition.

3) Measurement of Light Transmittance

Each of the polyimide films produced in Examples and Comparative Example was subjected to measurement of a UV-visible spectrum in a wavelength range of 300 to 800 nm with MultiSpec-1500 manufactured by Shimadzu Corporation to obtain a light transmittance at a wavelength of 400 nm.

4) Measurement of b* Value

Each of the polyimide films produced in Examples and Comparative Example was subjected to measurement of b* value, which is an index of yellowness, of the polyimide film in a transmission mode with a direct-reading tristimulus color meter (Color Cute i CC-i type) manufactured by Suga Test Instruments Co., Ltd.

5) Coefficient of Thermal Expansion (CTE)

Each of the polyimide films produced in Examples and Comparative Example was cut into a width of 4 mm and a length of 20 mm to prepare a sample. A temperature-specimen elongation curve is determined for the resulting sample with a thermal analysis apparatus (TMA-50) manufactured by Shimadzu Corporation, and the slope in the range of 60° C. to 160° C. was taken as a coefficient of thermal expansion (CTE).

6) Haze

Each of the polyimide films produced in Examples and Comparative Example was subjected to measurement of haze with a hazemeter (NDH2000) manufactured by Nippon Denshoku Industries Co., Ltd.

7) Total Light Transmittance

Each of the polyimide films produced in Examples and Comparative Example was subjected to measurement of total light transmittance in accordance with JAS K7105.

8) Retardation in the Thickness Direction (Rth) Per 10 μm in Thickness

The retardation in the thickness direction of the polyimide film was measured at a wavelength of 633 nm with a prism coupler (model 2010, manufactured by Metricon Corporation). The obtained value was converted into a value (Rth) per 10 m in thickness.

9) Tensile Strength, Tensile Modulus and Tensile Elongation

A dumbbell-shaped punched specimen was prepared and is subjected to measurement under the conditions of a gauge line width of 5 mm, a sample length of 30 mm and a tensile speed of 30 mm/min with a tensile tester (EZ-S, manufactured by Shimadzu Corporation). The strength and elongation at break, which were read from the obtained stress-strain curve, were taken as a tensile strength and a tensile elongation, respectively. The average value of the five measurement values was taken for each of these. The tensile modulus was determined from the stress-strain curve.

TABLE 2

| | | Monomer composition ratio | | Intrinsic viscosity | | | |
|---|---|---|---|---|---|---|---|
| | Synthesis | Tetracarboxylic | | of polyamide acid | Atmosphere | Heating | Film |
| | Example of | dianhydride component | Diamine component | η | for film | temperature | thickness |
| | polyamide acid | (content molar ratio) | (content molar ratio) | [dL/g] | formation | [° C.] | [μm] |
| Example 1 | Synthesis | ODPA/s-BPDA | 1,4-BAC/HMDA | 1.18 | Nitrogen | 220 | 12 |
| | Example 1 | (10/90) | (50/50) | | | | |
| Example 2 | Synthesis | s-BPDA | 1,4-BAC/HMDA | 1.00 | Nitrogen | 220 | 16 |
| | Example 2 | | (50/50) | | | | |
| Example 3 | Synthesis | ODPA/s-BPDA | 1,4-BAC/HMDA | 0.77 | Nitrogen | 220 | 17 |
| | Example 3 | (10/90) | (60/40) | | | | |
| Example 4 | Synthesis | ODPA/s-BPDA | 1,4-BAC/HMDA | 1.14 | Nitrogen | 220 | 14 |
| | Example 4 | (10/90) | (70/30) | | | | |
| Example 5 | Synthesis | ODPA/s-BPDA | 1,4-BAC/HMDA | 1.15 | Nitrogen | 220 | 11 |
| | Example 5 | (30/70) | (50/50) | | | | |
| Example 6 | Synthesis | ODPA/s-BPDA | 1,4-BAC/HMDA | 1.18 | Air | 220 | 12 |
| | Example 1 | (10/90) | (50/50) | | | | |
| Example 7 | Synthesis | s-BPDA | 1,4-BAC/HMDA | 1.00 | Air | 220 | 16 |
| | Example 2 | | (50/50) | | | | |
| Example 8 | Synthesis | ODPA/s-BPDA | 1,4-BAC/HMDA | 0.77 | Air | 220 | 17 |
| | Example 3 | (10/90) | (60/40) | | | | |
| Example 9 | Synthesis | ODPA/s-BPDA | 1,4-BAC/HMDA | 1.14 | Air | 220 | 13 |
| | Example 4 | (10/90) | (70/30) | | | | |
| Example 10 | Synthesis | ODPA/s-BPDA | 1,4-BAC/HMDA | 1.15 | Air | 220 | 11 |
| | Example 5 | (30/70) | (50/50) | | | | |
| Comparative | Comparative | ODPA/s-BPDA | 1,4-BAC/HMDA | 0.73 | Nitrogen | 220 | 17 |
| Example 1 | Synthesis | (50/50) | (50/50) | | | | |
| | Example 1 | | | | | | |

| | | | | Optical properties | | | | | | | |
|---|---|---|---|---|---|---|---|---|---|---|---|
| | Thermal properties | | | Light | | | | | | | |
| | | Starting | | transmittance | | | | | Mechanical strength | | |
| | | temperature of | | at wavelength | | | Total light | | Tensile | Tensile | Tensile |
| | Tg | decomposition | CTE | of 400 nm | b* | Haze | transmittance | Rth | strength | modulus | elongation |
| | [° C.] | [° C.] | [ppm/K] | [%] | value | [%] | [%] | [—] | [MPa] | [GPa] | [%] |
| Example 1 | 200 | 375 | 58 | 84 | 0.7 | 0.6 | 90 | 42 | 107 | 2.6 | 26 |
| Example 2 | 204 | 363 | 48 | 86 | 0.6 | 0.6 | 90 | 42 | 111 | 2.5 | 44 |
| Example 3 | 213 | 364 | 52 | 85 | 0.7 | 0.7 | 90 | 44 | 112 | 2.6 | 27 |
| Example 4 | 220 | 361 | 51 | 85 | 0.8 | 1.0 | 90 | 33 | 118 | 2.7 | 20 |
| Example 5 | 192 | 391 | 54 | 87 | 0.6 | 0.9 | 90 | 29 | 112 | 2.6 | 26 |
| Example 6 | 194 | 363 | 55 | 80 | 1.6 | 1.4 | 89 | 35 | 118 | 2.8 | 19 |
| Example 7 | 201 | 369 | 50 | 81 | 1.7 | 0.6 | 90 | 39 | 110 | 2.5 | 40 |
| Example 8 | 207 | 362 | 52 | 79 | 2.3 | 0.6 | 89 | 43 | 105 | 2.5 | 20 |
| Example 9 | 216 | 361 | 53 | 80 | 2.0 | 1.0 | 89 | 41 | 126 | 3.0 | 9 |
| Example 10 | 188 | 386 | 46 | 82 | 1.3 | 1.0 | 90 | 20 | 122 | 2.8 | 22 |
| Comparative | 185 | 397 | 56 | 75 | 1.5 | 0.7 | 90 | 30 | 106 | 2.4 | 20 |
| Example 1 | | | | | | | | | | | |

As shown in Table 2 above, when the polyamide acid is a polymerization product of a tetracarboxylic dianhydride component and a diamine component, wherein: the tetracarboxylic dianhydride component contains 60 to 100 mol % of 4,4′-oxydiphthalic anhydride (s-BPDA) based on the total amount of the tetracarboxylic dianhydride component; and the diamine component contains 30 to 70 mol % of an alicyclic diamine and 30 to 70 mol % of an alkylenediamine based on the total amount of the diamine component, the intrinsic viscosity (η) of the polyamide acid was 0.62 dL/g or more (Examples 1 to 10). The polyimide film obtained from such a polyamide had a glass transition temperature of 180° C. or more and 220° C. or less; a starting temperature of decomposition of 355° C. or more; a light transmittance at a wavelength of 400 nm of 77% or more and the b* value in the L*a*b* color system of 5 or less. Therefore, these polyimide films can be applied for various applications. In addition, since Tg is within the above-described range, thermocompression bonding is possible, for example, at approximately 250° C.

When a conventional polyimide is imidized under an air atmosphere, the polyimide tends to be colored and decrease in light transmission. In contrast, even when each of the polyimides of the above-described Examples was imidized in an air atmosphere, it did not excessively decrease in light transmittance, and it was also not easily colored (Examples 6 to 10).

On the other hand, the polyimide of Comparative Example 1, in which the amount of 4,4′-oxydiphthalic anhydride (s-BPDA) is less than 60 mol % based on the total amount of the tetracarboxylic dianhydride component, was low in transmittance.

The present application claims priority to Japanese Patent Application No. 2019-182840 filed on Oct. 3, 2019, the content of which is incorporated herein by reference in its entirety.

### INDUSTRIAL APPLICABILITY

The polyimide film of the present invention can be formed at a relatively low temperature, and it can be thermocompression bonded, for example, at approximately 250° C. It is low in coloring and is highly transparent. Therefore, it can be applied to an adhesive layer or a protective layer for various display elements.

1. A polyimide film comprising a polyimide that is a polymerization product of a tetracarboxylic dianhydride component and a diamine component, wherein:
the tetracarboxylic dianhydride component contains 60 to 100 mol % of any compound selected from the group consisting of the following compounds A to C based on the total amount of the tetracarboxylic dianhydride component; and
the diamine component contains 30 to 70 mol % of an alicyclic diamine and 30 to 70 mol % of an alkylenediamine based on the total amount of the diamine component:
compound A: a biphenyltetracarboxylic dianhydride optionally having 3 or less substituents consisting of alkyl groups having 1 to 4 carbon atoms;
compound B: a naphthalenetetracarboxylic dianhydride optionally having 3 or less substituents consisting of alkyl groups having 1 to 4 carbon atoms; and
compound C: a bisphenyl-based tetracarboxylic dianhydride optionally having 3 or less substituents consisting of alkyl groups having 1 to 4 carbon atoms, the bisphenyl-based tetracarboxylic dianhydride having any of the following structures:

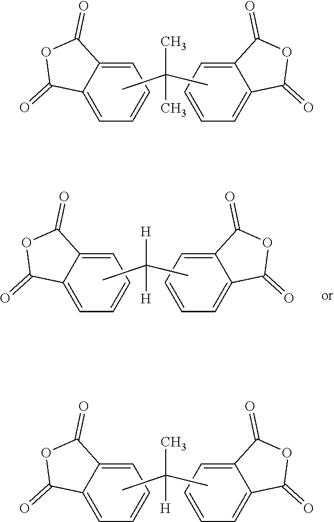

2. A polyimide film comprising a polyimide that is a polymerization product of a tetracarboxylic dianhydride component and a diamine component, wherein:
the tetracarboxylic dianhydride component contains 60 to 100 mol % of a biphenyltetracarboxylic dianhydride optionally having 3 or less substituents consisting of alkyl groups having 1 to 4 carbon atoms based on the total amount of the tetracarboxylic dianhydride component; and
the diamine component contains 30 to 70 mol % of an alicyclic diamine and 30 to 70 mol % of an alkylenediamine based on the total amount of the diamine component.

3. The polyimide film according to claim 1, wherein:
the alkylene group of the alkylenediamine has 2 to 12 carbon atoms.

4. The polyimide film according to claim 1 wherein:
the alicyclic diamine is at least one compound selected from the group consisting of 1,4-diaminomethylcyclohexane, 1,3-diaminomethylcyclohexane, norbornanediamine, cyclohexanediamine, isophoronediamine and 4,4′-methylenebis(cyclohexylamine).

5. The polyimide film according to claim 1, wherein:
the alicyclic diamine comprises 1,4-diaminomethylcyclohexane; and
the alkylenediamine comprises 1,6-hexamethylenediamine.

6. The polyimide film according to claim 1, wherein:
the tetracarboxylic dianhydride component contains 40 mol % or less of 4,4′-oxydiphthalic anhydride.

7. A polyamide acid that is a polymerization product of a tetracarboxylic dianhydride component and a diamine component, wherein:
the tetracarboxylic dianhydride component contains 60 to 100 mol % of any compound selected from the group consisting of the following compounds A to C based on the total amount of the tetracarboxylic dianhydride component; and
the diamine component contains 30 to 70 mol % of an alicyclic diamine and 30 to 70 mol % of an alkylenediamine based on the total amount of the diamine component:
compound A: a biphenyltetracarboxylic dianhydride optionally having 3 or less substituents consisting of alkyl groups having 1 to 4 carbon atoms;
compound B: a naphthalenetetracarboxylic dianhydride optionally having 3 or less substituents consisting of alkyl groups having 1 to 4 carbon atoms; and
compound C: a bisphenyl-based tetracarboxylic dianhydride optionally having 3 or less substituents consisting of alkyl groups having 1 to 4 carbon atoms, the bisphenyl-based tetracarboxylic dianhydride having any of the following structures:

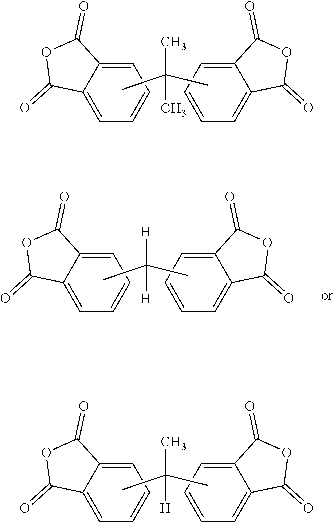

8. A polyamide acid that is a polymerization product of a tetracarboxylic dianhydride component and a diamine component, wherein:
the tetracarboxylic dianhydride component contains 60 to 100 mol % of a biphenyltetracarboxylic dianhydride optionally having 3 or less substituents consisting of alkyl groups having 1 to 4 carbon atoms based on the total amount of the tetracarboxylic dianhydride component; and
the diamine component contains 30 to 70 mol % of an alicyclic diamine and 30 to 70 mol % of an alkylenediamine based on the total amount of the diamine component.

9. The polyamide acid according to claim 7, wherein:
the alkylene group of the alkylenediamine has 2 to 12 carbon atoms.

10. The polyamide acid according to claim 7, wherein:
the alicyclic diamine is at least one compound selected from the group consisting of 1,4-diaminomethylcyclohexane, 1,3-diaminomethylcyclohexane, norbornanediamine, cyclohexanediamine, isophoronediamine and 4,4′-methylenebis(cyclohexylamine).

11. The polyamide acid according to claim 7, having an intrinsic viscosity of 0.62 dL/g or more.

12. The polyamide acid according to claim 7, wherein:
the alicyclic diamine comprises 1,4-diaminomethylcyclohexane; and
the alkylenediamine comprises 1,6-hexamethylenediamine.

13. The polyamide acid according to claim 7, wherein:
the tetracarboxylic dianhydride component contains 40 mol % or less of 4,4′-oxydiphthalic anhydride.

14. A polyamide acid varnish, comprising the polyamide acid according to claim 7 and a solvent.

15. A method for producing a polyimide laminate having a substrate and a polyimide layer laminated, comprising:
applying the polyamide acid varnish according to claim 14 onto the substrate; and
heating the coating film of the polyamide acid varnish under an inert gas atmosphere.

16. A method for producing a polyimide laminate having a substrate and a polyimide layer laminated, comprising:
applying the polyamide acid varnish according to claim 14 onto the substrate; and
heating the coating film of the polyamide acid varnish under an air atmosphere.

17. A polyimide laminate comprising:
a substrate; and
the polyimide film according to claim 1 disposed on or above the substrate.
